(19) United States
(12) Patent Application Publication
(10) Pub. No.: US 2006/0124228 A1
(43) Pub. Date: Jun. 15, 2006

(54) Apparatus and method for manufacturing copper clad laminate with improved peel strength

(75) Inventors: Sang Youp Lee, Gyeonggi-do (KR); Joon Sik Shin, Gyeonggi-do (KR); Hyung Wook Park, Gyeonggi-do (KR); Geum Hee Yun, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/297,831

(22) Filed: Dec. 7, 2005

(30) Foreign Application Priority Data
Dec. 15, 2004 (KR) 10-2004-0106433

(51) Int. Cl. B29C 65/02; B32B 27/00; B29D 31/00

(52) U.S. Cl. 156/199; 156/242

(57) ABSTRACT

The present invention relates to an apparatus and method for manufacturing a copper clad laminate, which can achieve a substantial improvement in the peel strength between a thermoplastic liquid crystal polymer and a copper foil. The apparatus comprises: a coating means for thinly coating the surface of a copper foil with a thermoplastic liquid crystal polymer solution; a solvent removal means for drying the coated liquid crystal polymer solution to remove the solvent of the coated solution; and a thermal pressing means for laminating and thermally pressing a thermoplastic liquid crystal polymer film onto the copper foil using heating rolls so as to make a copper clad laminate.

### INCORPORATION BY REFERENCE

The present application claims priority under 35 U.S.C. §119 to Korean Patent Application No. 10-2004-0106433 filed on Dec. 15, 2004. The content of the application is incorporated herein by reference in its entirety.

### BACKGROUND OF THE INVENTION

1. Field of the Invention

The present invention relates to an apparatus and method for manufacturing a copper clad laminate, and more particularly to an apparatus and method for manufacturing a copper clad laminate, which can substantially improve the peel strength between a thermoplastic liquid crystal polymer and a copper foil.

2. Description of the Prior Art

In general, printed circuit boards refer to products obtained by forming circuits on a copper clad laminate composed of a copper foil laminated on a material, such as paper phenol resin or glass epoxy resin, using techniques such as patterning and etching.

With the development of electronic technology, recent printed circuit boards become lighter in weight and smaller in size in order to mount parts at high integration density, and are of increasing importance as the basic factor for increasing integration density.

With this recent importance of printed circuit boards, copper clad laminates are also manufactured and used in various manners. Particularly with a surprising increase in the integration density of semiconductor integrated circuits and the development of surface mounting technology for directly mounting small chip parts, reductions in the weight and size of electronic products, such as mobile communication devices, are rapidly made. For this reason, the use of flexible printed circuit boards, which are mounted in spaces within electronic products much more easily than are existing rigid printed circuit boards (rigid PCBs), is increasing. Also, to achieve the high-density integration (HDI) of circuit patterns, the use of a multi-layer flexible PCB or a rigid-flexible multi-layer PCB is now rapidly increasing.

Meanwhile, as the material of these flexible and rigid-flexible printed circuit boards, polyimide is generally used. However, the polyimide used has a problem in dimensional stability due to high water absorption rate, and a shortcoming in that it shows reductions in dielectric constant (Dk) and dissipation factor (Df) in a high-frequency range (GHz range). For these reasons, a thermoplastic liquid crystal polymer (LCP) is spotlighted as a substitute material for the polyimide.

The thermoplastic liquid crystal polymer has high dimensional stability resulting from low water absorption rate (<0.1%), a thermal expansion coefficient similar to copper foil (16-18 ppm/° C.), and a low dielectric constant (Dk) and dissipation factor (Df) in a high-frequency range (GHz range). In view of these advantages, the thermoplastic liquid crystal polymer is expected not only to substitute for polyimide in the flexible and flexible-rigid printed circuit boards, but also to be applied as insulation material in HDI for mobile phones, semiconductors (e.g., BGA, CSP, etc.), network substrates, and the like.

Currently, leading global chemical companies, including Ticona-Polyplastics, Sumitomo and Dupont, produce and sell thermoplastic liquid crystal polymer resins. Also, companies, including Kuraray, Nippon Steel Chemical Co., Rogers, and Goretex, manufacture insulation films and flexible clad laminates (FCCL) for application to board materials by using the thermoplastic liquid crystal polymer resin.

Prior methods for manufacturing the flexible copper clad laminates can be broadly divided into the following two categories: (1) a manufacturing method comprising forming a roughness on the surface of a copper foil (12 or 18 μm) and thermally pressing a thermoplastic liquid crystal polymer film onto the copper foil by means of two heating rolls; and (2) a manufacturing method with the use of the press method used in the manufacturing of copper clad laminates, such as FR4 laminates.

The first method of manufacturing copper clad laminates by forming a roughness on the surface of a copper foil and thermally pressing a thermoplastic liquid crystal polymer film onto the copper foil is shown in FIG. 1. As shown in FIG. 1, in order to form circuit patterns on one or both sides of thermoplastic liquid crystal polymer film 110 which is transferred between reels 124a and 124b by drive rolls 126a and 126b, copper foil 112 passes through upper and lower press rolls 120 and 122 and, at the same time, is laminated onto the thermoplastic liquid crystal polymer film 110, thus manufacturing flexible copper clad laminate (FCCL) 100.

The second method of manufacturing copper clad laminates using the press method used in the manufacturing of FR4 copper clad laminates is shown in FIG. 2A. As shown in FIG. 2A, the manufacturing method comprises the steps of: preparing first and second solid metal press plates each having a flat surface; preparing first and second flat heating plates; preparing first and second copper foils; and sandwiching a thermoplastic liquid crystal polymer film between the first and second copper foils and thermally pressing the first and second copper foils onto the thermoplastic liquid crystal polymer film in a vacuum by the first and second metal press plates, thus forming a flexible copper clad laminate.

In the press method, among the prior methods, there is an advantage in that the copper clad laminate can be easily manufactured because the copper foils and the thermoplastic liquid crystal polymer film are pressed at the same time in a manner similar to the prior method of manufacturing copper clad laminates, such as FR4 laminates. However, the press method has shortcomings in that it is difficult to obtain products having uniform dimensional stability due to a difference in properties (e.g., thermal deformation with temperature) between the thermoplastic liquid crystal polymer and FR4, and that it has lower productivity than the method of manufacturing copper clad laminates by thermal pressing with the heating rolls.

Particularly for flexible or rigid-flexible PCBs, conversion to a roll-to-roll process is expected, and thus, there is a need for a method capable of manufacturing flexible clad laminates in a roll form.

In addition, the method with the use of heating rolls comprises forming a roughness on the surface of the copper foil in order to increase the peel strength between the copper foil and the thermoplastic liquid crystal polymer film, followed by thermal pressing. Also, in view of the problem of low dimensional stability which can occur in the press method, a preheating step is conducted before the thermal pressing in order to solve the problem of rapid thermal expansion caused by the thermal pressing at high temperature.

Kuraray Co., Ltd., Japan, has a number of pending patent applications relating to copper clad laminates manufactured with the thermoplastic liquid crystal polymer film and the copper foil (Japanese Patent Laid-Open Publication Nos. 2000-263577, 2000-343610, 2001-079946, 2001-079947, and 2003′-103700).

However, in the copper clad laminates manufactured by the press method and the thermal pressing method with the use of heating rolls, the peel strength between the copper foil and the thermoplastic liquid crystal polymer film is shown to be much lower than 0.8 kN/m which is the minimum level applicable to PCB materials. Accordingly, a need to improve this peel strength now exists.

### SUMMARY OF THE INVENTION

Accordingly, the present invention has been made to solve the above problems occurring in the prior art, and an object of the present invention is to provide an apparatus and method for manufacturing a copper clad laminate, which can substantially improve the peel strength between a thermoplastic liquid crystal polymer and a copper foil so that the copper clad laminate is applicable to PCB materials.

To achieve the above object, in one embodiment, the present invention provides an apparatus for manufacturing a copper clad laminate, comprising: a coating means for thinly coating the surface of a copper foil with a thermoplastic liquid crystal polymer solution; a solvent removal means for drying the coated liquid crystal polymer solution to remove the solvent of the coated polymer solution; and a thermal pressing means for laminating and thermally pressing a thermoplastic liquid crystal polymer film onto the copper foil by heating rolls so as to make a copper clad laminate.

In another embodiment, the present invention provides a method for manufacturing a copper clad laminate, comprising the steps of: coating the surface of a copper foil having a roughness formed thereon with a thermoplastic liquid crystal polymer solution to small thickness; drying the coated liquid crystal polymer solution to remove the solvent of the polymer solution; and laminating and thermally pressing a thermoplastic liquid crystal polymer film onto the copper foil by heating rolls so as to make a copper clad laminate.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a method for manufacturing copper clad laminates using rolls according to the prior art;

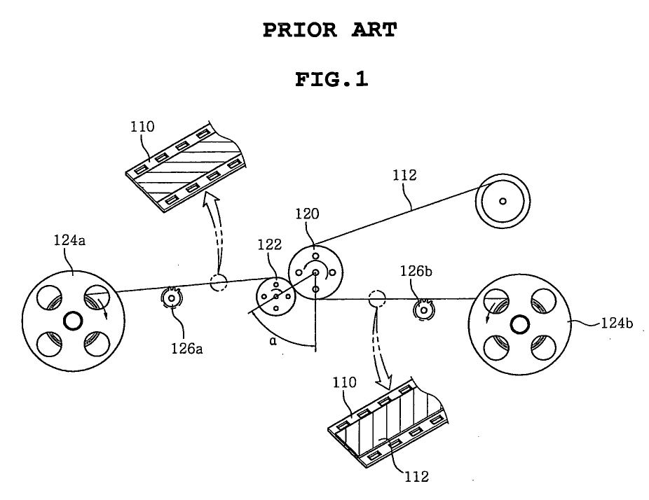

FIGS. 2A to 2B illustrate a method for manufacturing copper clad laminates using presses according to the prior art;

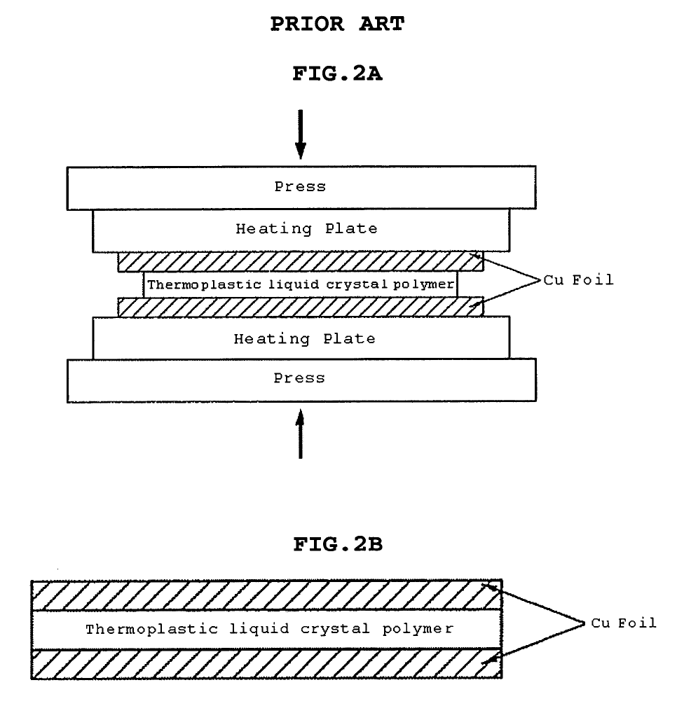

FIG. 3 shows the construction of an apparatus for manufacturing a copper clad laminate having improved peel strength, according to one embodiment of the present invention; and

FIG. 4 is a flow chart showing a method for manufacturing a copper clad laminate having improved peel strength, according to one embodiment of the present invention.

### DETAILED DESCRIPTION OF THE INVENTION

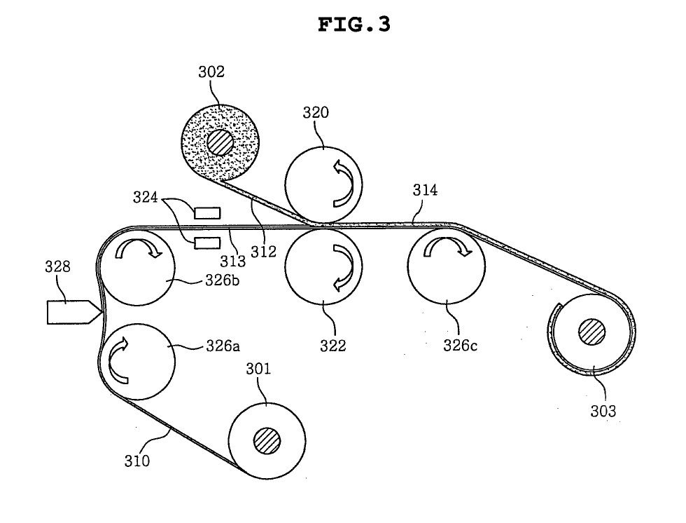

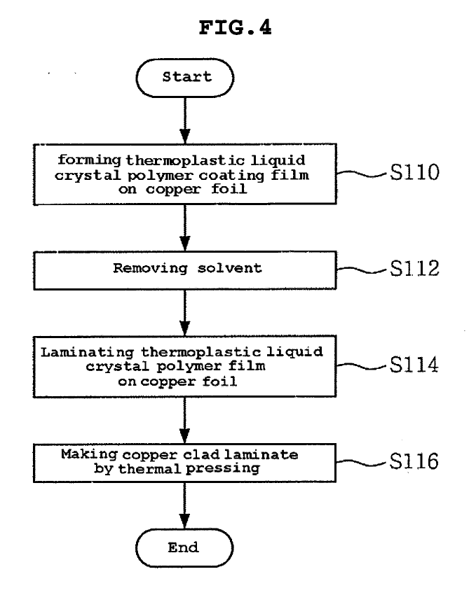

Hereinafter, an embodiment of the present invention will be described in detail with reference to FIGS. 3 and 4.

FIG. 3 shows the construction of an apparatus for manufacturing a copper clad laminate according to one embodiment of the present invention. As shown in FIG. 3, the manufacturing apparatus comprises: a copper foil feed roll 301; a thermoplastic liquid crystal polymer film feed roll 302; a copper clad laminate storage roll 303; a heating section 324 for heating copper foil 313 coated with a thermoplastic liquid crystal polymer; copper foil transfer rolls 326a and 326b for allowing the copper foil 310 fed from the copper foil feed roll 301 to pass through a coating section 328; heating rolls 320 and 322 for laminating a thermoplastic liquid crystal polymer film onto the thermoplastic liquid crystal polymer-coated copper foil passed through the heating section 324 and pressing and heating the laminate; and a copper clad laminate transfer roll 326c for transferring the copper clad laminate 314 discharged from the heating rolls 320 and 322 to the copper clad laminate storage roll 303.

As the copper foil is fed from the copper foil feed roll 301, the copper foil transfer rolls 326a and 326b cause the copper foil 310 to pass through the coating section 328. At this time, the copper foil 310 fed from the copper foil feed roll 301 has a roughness formed on the surface thereof, and due to the roughness, the thermoplastic liquid crystal polymer solution to be applied later will adhere well to the surface of the copper foil.

Then, in the coating section 328, the copper foil 310 is thinly coated with the thermoplastic liquid crystal polymer solution. Thanks to the coated polymer solution, the peel strength of a manufactured copper clad laminate can be highly improved compared to the prior art.

The thermoplastic liquid crystal polymer solution may contain filler in an amount of 0-30% by volume, in which the filler serves to reduce the thermal expansion coefficient and curling events.

Examples of the filler, which can be used in the present embodiment, include inorganic materials, such as silica, alumina, titania, and calcium carbonate, and organic materials, such as carbon and graphite. Coating the liquid crystal polymer solution on the copper foil having the roughness formed on the surface thereof may be performed using a roller coating, dip coating, spray coating, spinner coating, curtain coating, slot coating or screen printing processes.

After coating the copper foil with the thermoplastic liquid crystal polymer solution, the solvent of the polymer solution is removed by pre-drying at 50-100° C. for 30 minutes to 2 hours in the heating section 324, and then, completely drying at 250-300° C. for 1-4 hours.

Then, by the pressing rolls 320 and 322, the thermoplastic liquid crystal polymer film 312 fed from the thermoplastic liquid crystal polymer film feed roll 302 is laminated onto the thermoplastic liquid crystal solution-coated dried copper foil 313 passed through the coating section, and then, the laminate undergoes thermal pressing (i.e., heating and pressing), thus making the copper clad laminate 314.

In the process where the thermoplastic liquid crystal polymer film 312 is thermally pressed onto the copper foil 313 by the heating rolls 320 and 322, the thermal pressing is carried out at a higher temperature than the thermal deformation temperature of the liquid crystal polymer film. The reason why the thermal pressing process following the coating process is carried out as described above is that the copper clad laminate manufactured only by coating without thermal pressing will have the following problems: the problems of the surface flatness and thickness uniformity of a copper clad laminate; and the problem of curling caused by the shrinkage of the thermoplastic liquid crystal polymer during the drying process for removing the solvent.

Because the thermoplastic liquid crystal polymer solution applied in the coating section and the thermoplastic liquid polymer film thermally pressed by the heating rolls 320 and 322 are made of the same material, sufficient adhesion therebetween can be achieved by thermal pressing at a temperature higher than their thermal deformation temperature, a speed of 1-5 m/min, and a pressure of 1-10 MPa.

FIG. 4 is a flow chart showing a method for manufacturing a copper clad laminate having improved peel strength, according to one embodiment of the present invention.

As shown in FIG. 4, as a copper foil with a thickness of, for example, 12 μM, is fed from the copper foil feed roll, the copper foil transfer rolls cause the copper foil to pass through the coating section. In the coating section, the copper foil is thinly coated with a thermoplastic crystal polymer solution (step S110).

The thermoplastic liquid crystal polymer solution may contain filler in an amount of 0-30% by volume, in which the filler can serve to reduce the coefficient of thermal expansion.

Then, in the heating section, the solvent of the coated thermoplastic liquid crystal polymer solution is removed by, for example, pre-drying at 80° C. for 1 hour and then completely drying at 250° C. for 2 hours (step S112).

Then, onto the thermoplastic liquid crystal polymer solution-coated dried copper foil passed through the coating section, a thermoplastic liquid crystal polymer film having a thickness of, for example, 25 μm, a thermal deformation temperature of, for example, 260° C., and a melting point of, for example, 283° C., fed from the thermoplastic liquid crystal polymer film feed roll, is thermally pressed by the heating rolls at a temperature of 270° C., a speed of 1 m/minute, and a pressure of 3 MPa, thus making a copper clad laminate having a uniform thickness of, for example, 45 μm (steps S114 and S116).

The peel strength of the copper clad laminate manufactured using the above-described embodiment of the present invention was measured according to IPC-TM-650 2.4.8, and the result is shown in Table 1 below. In Table 1, comparative example 1 is a measurement result according to IPC-TM-650 2.4.8 for the peel strength of a copper clad laminate manufactured by thermally pressing a thermoplastic liquid crystal polymer film (melting point: 309° C.) onto a 12-μm-thick copper foil having rough (Rz: 2 μm) surface. Comparative example 2 is a measurement result according to IPC-TM-650 2.4.8 for the peel strength of a copper clad laminate manufactured by thermally pressing a thermoplastic liquid crystal polymer film (thermal deformation temperature: 275° C., and melting point: 295° C.) onto a 18-m-thick copper foil having a rough (Rz: 2 μm) surface.

TABLE 1

| | | Comparative | Comparative |
|---|---|---|---|
| | Invention | example 1 | example 2 |
| Peel strength (kN/m) | 0.8 | 0.33 | 0.3 |
| Measurement method | IPC 2.4.8 | IPC 2.4.8 | IPC 2.4.8 |

As can be seen in Table 1, the measured peel strengths were 0.8 kN/m for the inventive embodiment, 0.33 kN/m for comparative example 1, and 0.3 kN/m for comparative example 2, indicating that the inventive embodiment showed a great improvement in peel strength.

As described above, according to the present invention, the copper foil having a rough surface and the thermoplastic liquid crystal polymer solution are used to solve the problem of low peel strength in the prior copper clad laminate manufactured by the thermal pressing between a thermoplastic liquid crystal polymer and a copper foil. Also, the lamination of the thermoplastic liquid crystal polymer film by thermal pressing with the heating rolls is carried out to solve the problems of non-uniform thickness and the occurrence of curling which can occur upon coating. Accordingly, the present invention allows the manufacturing of a copper clad laminate having high peel strength, a flat surface, and uniform thickness, and at the same time, no curling problem.

Also in view of improved peel strength, the inventive copper clad laminate can be applicable to flexible and rigid-flexible printed circuit boards, and the rough copper foil surface, in the manufacturing of multilayer PCBs, will make a lamination process easy.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for manufacturing a copper clad laminate, comprising:
a coating device for thinly coating a surface of a copper foil with a thermoplastic liquid crystal polymer solution;
a solvent removal device for drying the coated liquid crystal polymer solution to remove the solvent of the coated polymer solution; and
a thermal pressing device for laminating and thermally pressing a thermoplastic liquid crystal polymer film onto the copper foil.

2. The apparatus of claim 1, wherein the coating device comprises:
a coating section coating the thermoplastic liquid crystal polymer solution onto the copper foil having a roughness formed thereon to coat the copper foil; and
copper foil transfer rolls transferring a copper foil fed from a copper feed roll to the coating section.

3. The apparatus of claim 1, wherein the solvent removal device comprises a heating section removing the solvent by pre-drying at a first temperature for a first predetermined time, and completely drying at a second temperature for a second predetermined time.

4. The apparatus of claim 3, wherein the first temperature is 50-1,000° C., the first predetermined time is 30 minutes to 2 hours, the second temperature is 250-300° C., and the second predetermined time is 1-4 hours.

5. The apparatus of claim 1, wherein the thermal pressing device comprises heating rolls to make the copper clad laminate by thermal pressing at a temperature higher than the thermal deformation temperature of the polymer film, a speed of 1-5 m/minute, and a pressure of 1-10 MPa.

6. The apparatus of claim 1, wherein the thermoplastic liquid crystal polymer solution includes a filler for reducing the coefficient of thermal expansion.

7. A method for manufacturing a copper clad laminate, comprising the steps of:
thinly coating a surface of a copper foil having a roughness formed thereon with a thermoplastic liquid crystal polymer solution;
drying the coated liquid crystal polymer solution to remove the solvent of the thermoplastic liquid crystal polymer solution; and
laminating and thermally pressing a thermoplastic liquid crystal polymer film onto the copper foil by heating rolls.

8. The method of claim 7, wherein the thinly coating step comprises the steps of:
transferring the copper foil fed from a copper foil feed roll to a coating section; and
coating the thermoplastic liquid crystal polymer solution onto the copper foil having the roughness formed thereon to coat the copper foil.

9. The method of claim 7, wherein the drying step comprises the steps of:
pre-drying the polymer solution coated on the copper foil at a first temperature for a first predetermined time using a solvent removal device; and
completely drying the polymer solution coated on the copper foil at a second temperature for a second predetermined time to remove the solvent of the polymer solution.

10. The method of claim 7, wherein the thermal pressing in the laminating and thermally pressing step is carried out at a temperature higher than the thermal deformation temperature of the polymer film, a speed of 1-5 m/minute, and a pressure of 1-10 MPa.

11. The method of claim 7, wherein the thermoplastic liquid crystal polymer solution includes a filler for reducing the coefficient of thermal expansion.
